(19) United States
(12) Patent Application Publication
(10) Pub. No.: US 2003/0156778 A1
(43) Pub. Date: Aug. 21, 2003

(54) Optical interconnection system in a microelectronic circuit produced on a soi substrate

(76) Inventors: Suzanne Colette Marion Laval, Gif-Sur-Yvette (FR); Alain Georges Henri Koster, Orsay (FR); Daniel Albert Pascal, Forges Les Bains (FR); Francois Anceau, Plaisis (FR)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/333,223

(22) PCT Filed: Jul. 26, 2001
(86) PCT No.: PCT/FR01/02456

(30) Foreign Application Priority Data
Jul. 27, 2000 (FR) 00/09851

(51) Int. Cl. G02B 6/12

(52) U.S. Cl. 385/14

(57) ABSTRACT

This invention relates to an optical interconnection system in a microelectronic circuit made on an SOI substrate (30), in other words a substrate with a silicon film (13, 33, 53) supported by a layer of electrically insulating material (32), the microelectronic circuit comprising at least one function block to be connected made in the silicon film. The system comprises at least one optical microguide composed of a strip (40) delimited in the silicon film by lateral confinement areas (41, 42) to connect the function block.

### TECHNICAL DOMAIN

The invention relates to a system for optical interconnection in a microelectronic circuit (or integrated circuit) made on an SOI substrate. In particular, it relates to an interconnection system for the optical distribution of a clock signal between different blocks in a microelectronic circuit.

### STATE OF PRIOR ART

The microelectronics industry has started to change to Silicon-On-Insulator (SOI) substrate technologies to enable a technological leap resulting in an increase in speed of at least 20%. Memories and microprocessors have been developed on these substrates.

One crucial point that affects the limitation of performances of integrated circuits, taking account of their increasing complexity, is interconnections. Existing technologies use seven interconnection levels that occupy a large amount of space and limit circuit speed performances. The replacement of aluminium by copper to make these interconnections has improved performances, but this improvement is not enough for future generations of integrated circuits.

Furthermore, optic has been introduced into telecommunication systems and optical interconnections are gradually developing for short distances (cabinets, baskets, backpanels, etc.).

It was also proposed to make optoelectronic components on SOI substrates using the surface film of silicon as a low loss wave guide in the near infrared. Thus, the “Optical modulation at 1.3 μm on silicon-on-insulator (SIMOX) standard substrate for spatial light modulator applications” article by N. LANDRU et al., published in Electronics Letters, Jan. 20, 2000, vol. 36, No. 2, pages 161 to 163, discloses a light modulator comprising a ring structure. Light propagates in the silicon film of the SOI substrate. Lateral confinement of light in the silicon film is obtained by doping of regions of the film.

U.S. Pat. No. 6,063,299 discloses a manufacturing process on a silicon on insulator type (SOI) substrate, to make single mode wave guides with edges and wide section (edge width and silicon film thickness typically equal to 3 to 5 μm). These guides are based on integrated optical circuits associated with optical fibres.

### SUMMARY OF THE INVENTION

It is proposed in this invention to make optical microguides in the silicon film of an SOI substrate to obtain optical interconnections within electronic integrated circuits using the CMOS technology.

The invention is particularly applicable to the distribution of clock signals. It will solve one of the foreseeable blocking points in the “roadmap” for the period 2005 to 2010, namely the distribution of clock signals in circuits comprising several hundred million transistors with clock frequencies equal to about ten gigahertz.

Therefore, the purpose of the invention is an optical interconnection system in a microelectronic circuit made on SOI substrate, in other words a substrate with a silicon film supported by an electrically insulating material, the microelectronic circuit comprising at least one function block to be connected made in the silicon film, the optical interconnection system comprising at least one optical microguide composed of a strip delimited in the silicon film by lateral confinement areas to connect the function block.

The lateral confinement areas may be etched areas of the silicon film filled with a confinement material, for example a silicon oxide or a silicon nitride. They may be oxidized areas of the silicon film.

Advantageously, the microelectronic circuit comprises several function blocks, the interconnection system is arranged between function blocks, under the routing channels in this microelectronic circuit.

In particular, this interconnection system may be a clock signal distribution system.

Another purpose of the invention is a process for making a microelectronic circuit on an SOI substrate, in other words a substrate with a silicon film supported by a layer of an electrically insulating material, the microelectronic circuit including at least one function block made in the silicon film and connected through an interconnection system, the process being characterised in that it comprises:

steps for making the function block,

steps for making at least one optical microguide composed of a strip delimited in the silicon film by lateral confinement areas in order to obtain an optical interconnection system for connection of the function block.

Advantageously, at least some of the steps in manufacturing of the function block and steps in manufacturing of the optical microguide are carried out simultaneously.

### BRIEF DESCRIPTION OF THE DRAWINGS

The invention will be better understood and other advantages and features will become clear after reading the following description, given as a non-limitative example, accompanied by the attached drawings in which:

FIGS. 1A to 1C illustrate a first variant embodiment of an optical microguide for an optical interconnection system according to this invention,

FIGS. 2A to 2C illustrate a second variant embodiment of an optical microguide for an optical interconnection system according to this invention,

FIG. 3 shows a cross section of part of an integrated circuit showing the location of the optical microguides according to this invention.

### DESCRIPTION OF THE PREFERRED EMBODIMENTS

The SOI substrate is generally composed of a silicon substrate supporting an oxide layer and a silicon film in sequence, in which electronic devices are made. This silicon film naturally forms an optical wave guide at wavelengths in the near infrared used in optical telecommunications (1.3 μm). A microguide tree with a width of less than 1 μm can be made in it, accepting low radii of curvature. These microguides may be made using technological steps for manufacturing integrated circuits wherever possible. They may be placed in the space available under routing channels, between function blocks forming a VLSI circuit (on the same chip).

Light may be injected at the edge of the chip, either from an optical fibre using the dielectric layers for the isolation of metallic connections and a transfer of light at the root of the microguide tree through a diffraction grating coupler, or by direct coupling of a laser diode to the microguide. The optical signal is modulated either directly by modulation of the laser diode current, or by integration of an SiGe/Si quantum well modulator. The optical signal is detected by an integrated photodetector, either of the metal-semiconductor-metal (MSM) type or based on SiGeC.

The silicon film in an SOI substrate naturally forms an optical wave guide at the wavelengths of optical telecommunications. These optical wave guides on SOI substrate and the performances of end components (modulators and detectors) under development on silicon make it possible to consider making optical transmissions at frequencies of several GHz inside an integrated circuit chip.

These elements must be designed taking account of the manufacturing technology of circuits so that manufacturing steps for CMOS or BiCMOS transistors can be used wherever possible and to make it realistic to insert optical elements into VLSI integrated circuits. If the clock signal is distributed optically, this application of the invention reduces phase differences and therefore gives better synchronism in the circuit.

The inventors of this invention have verified that the silicon film of a SIMOX (Separation by IMplanted OXygen) type SOI substrate can give a very good optical guide at a wave length of 1.3 μm, although this film is very thin (0.2 μm) in standard substrates used in microelectronics and the thickness of the silicon film is limited (0.45 μm). Propagation losses measured in plane guides in this type of substrate are of the order of 5 dB/cm, which corresponds to leakages of light to the solid part of the substrate due to the thinness of the buried layer of silica.

Other SOI substrates, and particularly SOI substrates marketed by the SOITEC company under the name Unibond, give greater freedom in the choice of thicknesses of the buried silica layer and the silicon film. Therefore, this type of substrate can make it possible to make optical guides with extremely low propagation losses. These thicknesses can then be chosen such that losses by leakage of light to the solid part of the substrate through the buried silica layer are negligible. These thicknesses may also be chosen such that the optical guide can be almost single mode regardless of the polarization of light (TE or TM) and so that coupling of light in the guide is optimum.

The high difference in the refraction index between silicon and silica gives strong confinement of the electromagnetic field in the wave guide. The electromagnetic field may be confined laterally by delimiting a strip (that forms a two-dimensional guide) either by etching the silicon film and depositing silica or nitride in the etched areas, or by oxidation. It is thus possible to make narrow microguides (of the order of 1 μm wide) with a spacing of only a few μm between them and capable of accepting radii of curvature of the order of 5 μm without prohibitive losses. Several of these microguides can then be arranged in the available space between the function blocks of an integrated circuit, under the routing channels.

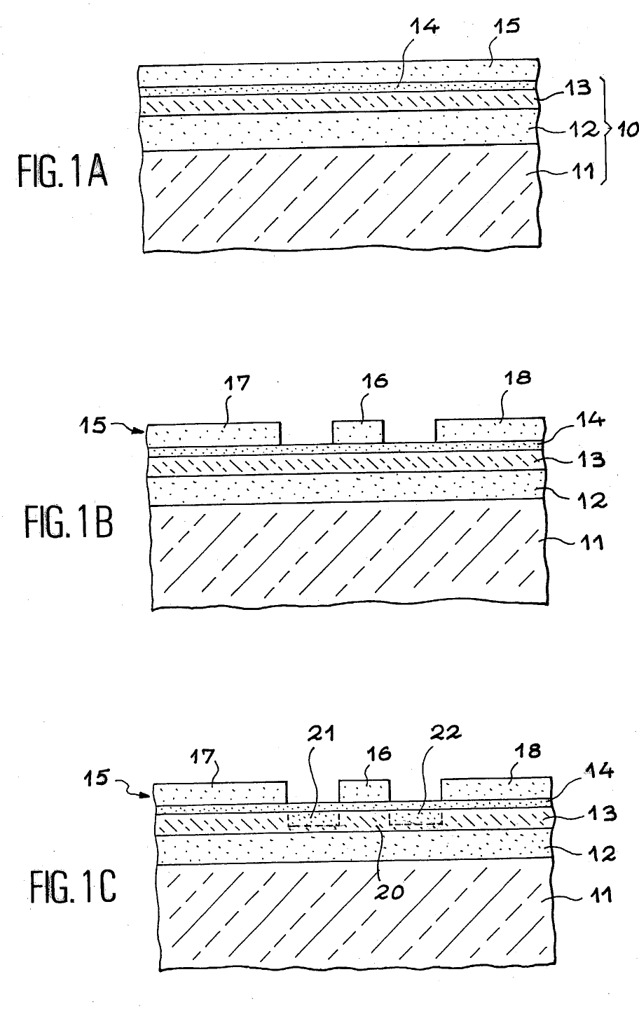

FIGS. 1A to 1C show partial cross sectional views. FIG. 1A shows an SOI substrate 10 of a standard type for microelectronics. The substrate 10 is composed of a solid part or support 11 made of silicon supporting a silicon oxide layer 12 followed by a silicon film 13. The initial thickness of the silicon film 13 is usually of the order of 0.2 μm. The film 13 will be thinned to about 0.1 μm so that transistors can be made in it. Nevertheless, the parts of the film reserved for optics must maintain a minimum thickness of 0.2 μm to limit leakages of light to the support 11.

A first variant embodiment of a microguide compatible with microelectronic processes is to deposit a silicon nitride layer 15 on the film 13 of the substrate 10 that was previously thermally oxidized to maintain the quality of the interface. Therefore, the film 13 supports an approximately 30 nm thick layer 14 of the thermal oxide, followed by a silicon nitride layer 15.

All optical components to be made (guides, beam divider, coupling networks) are then delimited by photolithography and the full thickness of the nitride layer 15 is etched. FIG. 1B shows this lateral delimitation for a wave guide. Etching of the layer 15 provides a part 16 delimiting the width of the wave guide to be obtained and parts 17 and 18 on each side of the part 16, and delimiting the lateral confinement areas of the wave guide.

The nitride layer 15 is then used as a mask for partial oxidation of the silicon film 13. This oxidation defines the geometry of the optical components. FIG. 1C shows the lateral confinement areas 21 and 22 obtained, the part 20 made of silicon forming the core of the wave guide. The silicon film 13 must be thinned in the regions in which components such as transistors will be made.

This manufacturing technique gives good quality optical interfaces between the silicon guide and the confinement silica.

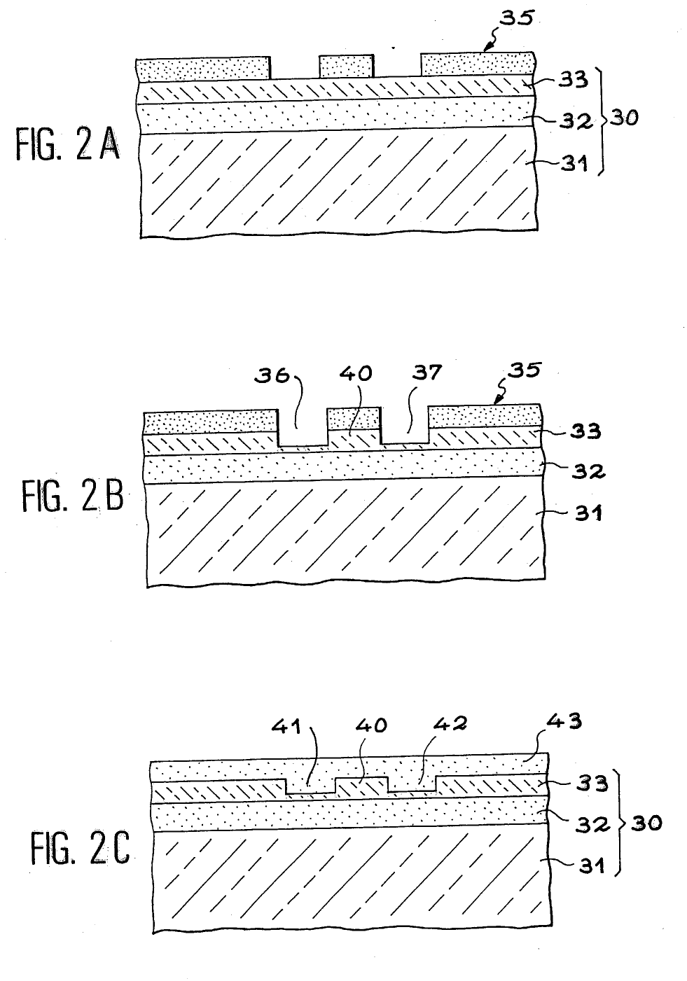

Another technique for delimiting microguides is to etch all or some of the silicon film to form trenches in it that can go as far as the buried silica layer. This is illustrated in FIGS. 2A to 2C which show partial cross sectional views.

FIG. 2A shows an SOI substrate 30 composed of a solid part or support 31 made of silicon supporting a silicon oxide layer 32 and then a silicon film 33. A resin mask 35 was formed on the film 33 to delimit a wave guide to be made in the film 33.

FIG. 2B shows the result obtained after etching the film 33 through the mask 35. Two trenches 36 and 37 define the location of lateral confinement areas, the part 40 made of silicon forming the core of the wave guide. The mask 35 is then withdrawn.

FIG. 2C shows the result obtained after deposition of a silica layer 43 on the etched silicon film 33. The silica fills in the previously made trenches to create lateral confinement areas 41 and 42.

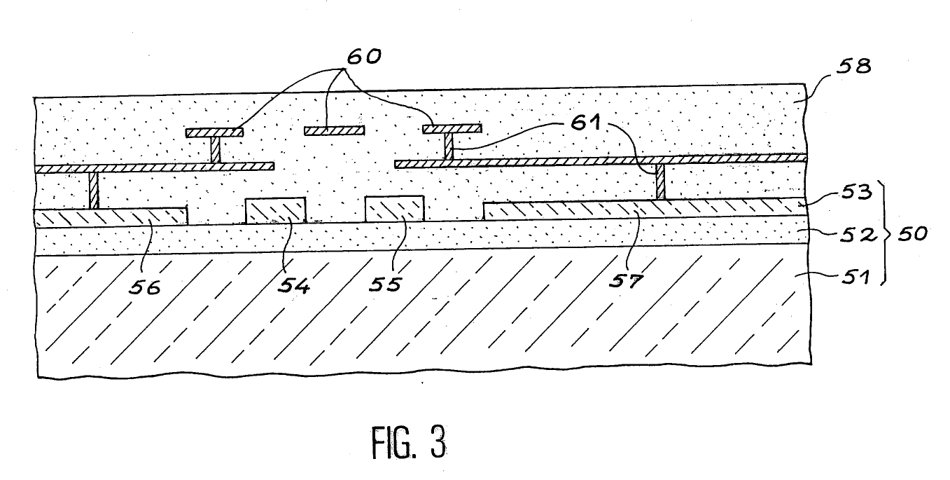

FIG. 3 shows a cross sectional view of part of an integrated circuit showing the location of optical microguides according to this invention.

The SOI substrate 50 is composed of a silicon support 51 supporting a silica layer 52 and a silicon film 53. An optical interconnection system was made from the silicon film 53 comprising silicon strips 54 and 55 delimited by lateral confinement areas. Function blocks 56 and 57 were also made in the silicon film 53. A layer 58, that is actually a superposition of several layers, covers the silicon film 53. The layer 58 forms lateral confinement for the silicon strips 54 and 55. It incorporates horizontal electrical connections in the routing ducts 60 and vertical connections 61 between the metallization levels and to the function blocks 56 and 57. FIG. 3 clearly shows that the optical interconnection system is arranged between function blocks 56 and 57 and under the routing channels 60.

The reduction in the size of the patterns and the increase in the size of circuits significantly increase their size compared with the size of a transistor. One of the consequences of this change is that clocks with a suitable frequency for controlling a module with about a million transistors are no longer capable of making correct phase relations for “long distance” exchanges through the chip. Integrated circuit designers naturally solve this problem by using a hierarchy of clocks with decreasing frequencies for clock control over exchanges within blocks, between blocks, and for exchanges through the chip. It is important to maintain precise phase relations between the difference clock levels, to avoid asynchronism problems due to phase differences between these clocks which can cause problems such as metastability.

The characteristics of the optical distribution of the clock according to this invention enable the user to transport the clock more quickly. Each block will detect the clock to generate its own local electrical timing system. Clocks with more global levels will be obtained by detection and division of the optical clock. They will be distributed electrically. A phase loop will align the phase of its fast clock onto the phase of the communication, at each block.

1. Microelectronic circuit made on an SOI substrate (10, 30, 50) in other words a substrate with a silicon film (13, 33, 53) supported by a layer of electrically insulating material (12, 32, 52), the microelectronic circuit comprising at least one function block (56, 57) made in the silicon film,, the function block being connected by an interconnection system, characterised in that the interconnection system includes an optical interconnection system comprising at least one optical microguide composed of a strip (20, 40, 54, 55) delimited in the silicon film (13, 33, 53) by lateral confinement areas to connect the function block.

2. Microelectronic circuit according to claim 1, characterised in that the areas of lateral confinement (41, 42) are etched areas of the silicon film (33) filled with a confinement material.

3. Microelectronic circuit according to claim 2, characterised in that the confinement material is a silicon oxide or a silicon nitride.

4. Microelectronic circuit according to claim 1, characterised in that the lateral confinement areas (21, 22) are oxidized zones of the silicon film (13).

5. Microelectronic circuit according to any one of claims 1 to 4, characterised in that the microelectronic circuit comprises several function blocks, and the optical interconnection system is placed between the function blocks (56, 57) under the routing channels (60) of this microelectronic circuit.

6. Microelectronic circuit according to any one of claims 1 to 5, characterised in that it is a clock signal distribution system.

7. Process for making a microelectronic circuit on an SOI substrate (10, 30, 50), in other words a substrate with a silicon film (13, 33, 53) supported by an electrically insulating material layer (12, 32, 52), the microelectronic circuit then comprising at least one function block (56, 57) made in the silicon film and connected through an interconnection system, the process being characterised in that it comprises:
steps for making the function block (56, 57),
steps for making at least one optical microguide composed of a strip (20, 40, 54, 55) delimited in the silicon film (13, 33, 53) by lateral confinement areas in order to obtain an optical interconnection system for connection of the function block (56, 57).

8. Process according to claim 7, characterised in that at least some of the manufacturing steps for the function block and manufacturing steps for the optical microguide are carried out simultaneously.
